(19) United States
(12) Patent Application Publication
(10) Pub. No.: US 2017/0240448 A1
(43) Pub. Date: Aug. 24, 2017

(54) INTEGRATED SYSTEM FOR CHEMICAL REACTION, SEDIMENTATION AND OXIDATION IN WATER TREATMENT PROCESSES

(71) Applicant: Molecular Filtration, Inc., Keller, TX (US)

(72) Inventors: Felipe Lembcke, Keller, TX (US); Eduardo Gomez-Maqueo, Keller, TX (US)

(21) Appl. No.: 15/049,041

(22) Filed: Feb. 20, 2016

(51) Int. Cl. C02F 9/00; C02F 1/52; C02F 1/56; C02F 1/74; C02F 1/76; C02F 1/72; B01D 21/01; B01D 21/30; B01D 21/00; C02F 1/24; C02F 1/78

(52) U.S. Cl. CPC C02F 9/00; C02F 1/24; C02F 1/5281; C02F 1/5209; C02F 1/5236; C02F 1/56; C02F 1/74; C02F 1/78; C02F 1/727; B01D 21/01; B01D 21/30; B01D 21/0084; C02F 1/76; C02F 2303/04; C02F 2101/20

(57) ABSTRACT

The present invention provides for a multi-stage water treatment system for a plurality of aqueous solutions generated in municipal and industrial processes, e.g., oil and gas field operations, poultry processing, meat processing, dairy processing, and mineral extraction among others. A sequence of different processing steps is carried out, based on the characterization of the composition of contaminants present in the water to be treated. The steps to be carried out include chemical reaction in a series of reactor tanks, sedimentation in slanted plates chamber, air flotation and disinfection, hydrocarbon recovery by a scraper located in a flotation cell. A series of conventional methods are selected to be applied in series for the removal of the contaminants. The process design of an integrated chemical reaction, sedimentation and oxidation system to be used in water treatment of aqueous effluents is presented which is suitable for municipal and industrial processes.

### FIELD OF THE INVENTION

The present invention relates to systems and methods for treating process water resulting from industrial processes that contain heavy metals.

### BACKGROUND

The presence of heavy metals in the process water stream poses a problem for the disposal of the waste streams for many industrial processes.

In oil and gas processes, for example, these heavy metals come along with carbonates, chlorides, sulfates and other inorganic salts, bacteria and hydrocarbons. The presence of these metals requires substantially difficult treatment before the water is reused or even disposed.

Similarly, the waste water coming from meat and dairy processing contains a variety of organic components which are a fertile medium for bacterial growth.

Furthermore, industrial operations are usually carried out in one place and treatment facilities are located in a different place, requiring the waste stream to be transported from one place to the other. During transport, additional contaminants may be transferred to the waste stream and bacterial growth in the transportation lines is common. Therefore, a versatile method to better suit the treatment process is required in order to reduce the amount of contaminants present in the waste stream.

Many types of industrial processes commonly result in process waste water containing multiple contaminants. The concentration and toxicity of the materials define the proper treatment options before final disposal.

Several treatment methods have been used in municipal and industrial waste water processing are known, such as those described by Peters et al (1, 2).

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

The present invention presents an integrated system using chemical reaction and sedimentation to treat effluents from municipal and waste water industrial processes.

A multipurpose device or process was designed to provide versatility in the treatment requirements for effluent water solutions. The methods used on each stage of the process have been used in water treatment for some time and commonly known in the art.

By integrating several treatment processes into a compartmentalized system, the benefits of each treatment process is increased by the synergy between itself and the next process, allowing for a smaller footprint and better control of the clarified stream quality produced by the system. The proposed design includes the possibility of three chemical treatment species to be employed as applicable to the chemical analysis of the waste stream to be treated and a sedimentation chamber to allow the separation of the sludge formed by the chemical treatment and the agglomeration of particles in the stream, such that the agglomeration can be air-floated and scraped from the surface in an air flotation chamber. This allows recovery of potentially high value products, e.g., oil, from the oil and gas field operations, as well as clarification and recovery of the water.

### BRIEF DESCRIPTION OF THE DRAWINGS

FIG. 1 shows a process diagram for one embodiment of the invention.

FIG. 2 is a top view of one embodiment of the optional portable construction of the invention.

FIG. 3 is a side view of one embodiment of the optional portable construction of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

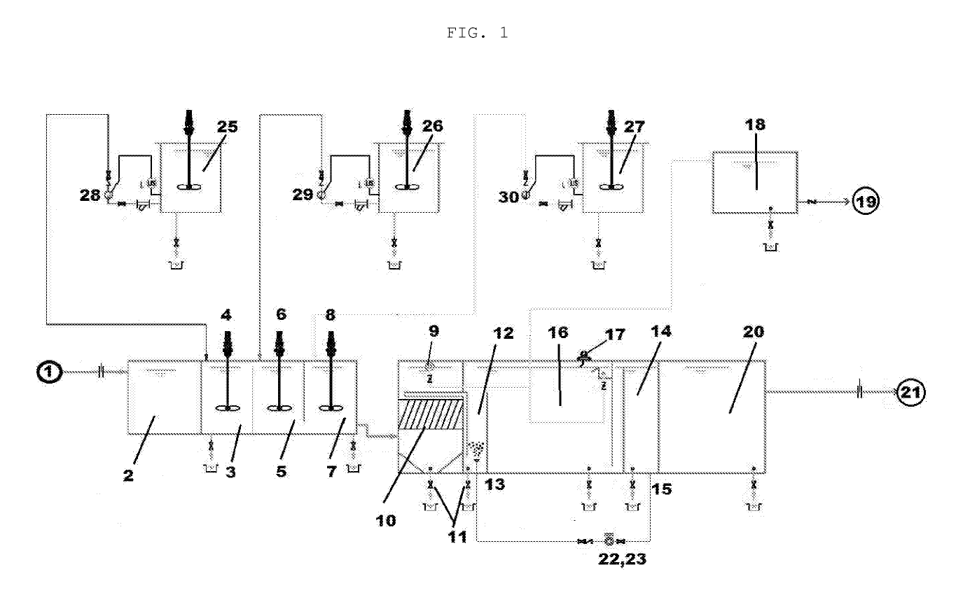

Referring now to the embodiments shown in FIGS. 1-3, the invention is a waste water treatment apparatus and a method of use as now described in detail.

The device is an integrated water and waste water treatment system comprising: three chemical reactors, a sedimentation¹ chamber, an air flotation device, a disinfection element, and oil separation design for the treatment of water and waste water systems. ¹ This application may make reference to having a “sedimentation chamber” or ‘precipitation chamber’ or a ‘sedimentation/precipitation chamber’ but all three refer to the same chamber.

Optional construction approaches to the apparatus includes making it portable, mixers in the chemical reactors, and a hydrocarbon recovery component in the flotation chamber. A holding tank for the treated (clarified) water is located after the air flotation tank, as well as a collection tank for the oil and sludge which floated with it.

Since most waste process streams possess contaminants of different nature, the design provides three different reaction zones, where the appropriate chemical can be used to attack a specific type of contaminant.

Each contaminant can be met by one or chemical treatments, elements, including caustic soda, acids, coagulants, fatty acid-amine soaps and polymers, among others, selected to provide the specific treatment for a particular contaminant.

The chemical dosing is calculated and programmed into the dosing pumps based on the water analysis of the waste water to be treated.

The size of the reactor is based on the flow requirements and the resident time needed for the chemical to carry out its job. The reactor sections are connected in series, so the outlet of the first reactor tank is connected to the inlet of the second one, and the outlet of the second reactor tank is connected to the inlet of the third one. This provides the flexibility of using different chemicals to treat the waste water based on the chemical analysis.

After the reaction section, the semi-treated water stream enters a tank with inclined plates for the purpose of sedimentation of the solid suspended in the stream, and to facilitate the oil recovery by allowing the oil particles to aggregate. The inclined plates provide a settling surface where the larger particles are deaccelerated and aggregate to settle down to the bottom of the tank. Oil and less dense particles are collected floating on the top, while the settled particles are collected on the bottom, where they can be removed as sludge for proper disposal.

This sedimentation tank is connected to an air flotation tank, where air can be used to aid the flotation of the oil particles which in turn can be scraped from the surface by a scraper. Air is injected in the lower part of the tank, or a different gas can be used if required. Chlorine or Ozone, for instance, can be used to disinfect the stream by killing bacteria present in the stream. The chemical analysis of the effluent stream will provide the appropriate gas to be used in this section.

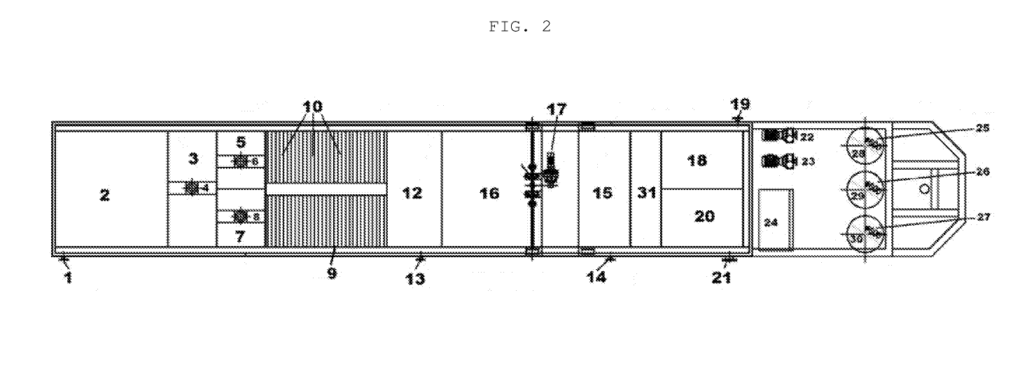

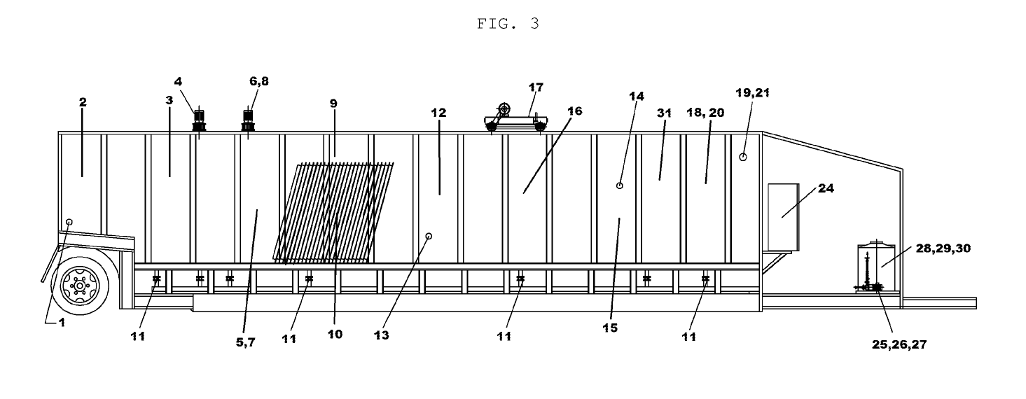

As is illustrated in FIGS. 2 and 3, the invention is most useful when portable. This preferred embodiment as shown is fitted into a mobile unit capable to be transported in the road meeting U.S. DOT transportation regulations. In the figure presented, the unit is fitted in a 50-ft. trailer, less than 7 ft. wide and 10 ft. tall, which may be easily transported in regular roads. Upon transportation to the site where the contaminated water source resides, it may be connected via an Inlet Port (1) located on the side of unit towards the back.

The fluid is pumped to the Influent Tank (2) until it is full with liquid. Once the Influent Tank (2) is full, it starts feeding the subject aqueous stream to the First Reaction Tank (3) and the Chemical Dosing Pump (25) starts injecting the desired chemical species for the first treatment process from a Chemical Tank (28) located towards the front of the unit.

The dosing flow-rate is controlled from the Control Panel (24) by the operator based on the chemical analysis of the subject aqueous stream to be treated. In a typical application setting, for most cases, the first chemical treatment used is sodium hydroxide to precipitate heavy metals. The precipitate is kept in suspension and the reaction is homogenized by having the tank well mixed by means of an Agitator (4).

The mixture with suspended solids enters the Second Reactor (5) where a second chemical is injected by a Chemical Dosing Pump (26) from a Chemical Tank (29) located in the front section of the unit.

As before, the chemical dosing flow-rate is controlled from the Control Panel (24) by the operator based on the chemical analysis of the problem aqueous mixture.

In a typical operation, the second chemical could be a polymer to facilitate the precipitation or sequestering the precipitates. Also coagulants or flocculants may be used depending on the type of contaminant to be attacked. As before, the contents of this Second Reactor Tank (5) are kept well mixed; solids are suspended by means of an Agitator (6) housed on the top of the Tank (5). Most of the applications require the removal of anionic and cationic species, so in typical operations, the use of an anionic polymer in this reactor and a cationic polymer in the next reactor could be an option.

The treated water exits the Second Reactor (5) to a Third Reactor Tank (7) located to the side of Second Reactor Tank (5). As before, the desired chemical is injected by a Dosing Pump (27) from a Chemical Tank (30) located towards the front of the unit.

The appropriate dosing flow-rate is controlled from the Control Panel (24) by the operator based on the chemical analysis of the subject aqueous stream. The sequestered precipitate compounds generated by the chemical reaction are maintained in suspension by an Agitator (8) housed on the top of the Reactor Tank (7). The agitation provides better contact between the chemicals used and the contaminants allowing the reaction to take place more efficiently.

The stream exits the third reactor tank to enter a slanted plate Precipitation Tank (9), where a series of inclined plates (10) allow the particles in suspension to be slowed down and precipitate to the bottom of the tank. The precipitates are collected on the bottom of the tank to remain there until removed as sludge from a Discharge Pipe (11) located at the bottom of the Tank (9). The semi-clarified water stream exits the Precipitation Tank (9) to a chamber where air or a gas is injected in, named as the Dissolution Chamber (12).

This embodiment has a treatment capacity of 50 gallons/minute, which allows for the proper residence time in the different stages of the process.

Air is pumped from the Air Pump (22) located at the front of the unit, to the Side Inlet (13) of the Dissolution Chamber (12), whereas the Air Pump (23) is connected via the Side Inlet (14) to a Secondary Air Dissolution Chamber (15). The air or gas flow-rate is controlled at the Control Panel (24) based on the amount of oil or light-density contaminants present in the stream.

In some embodiments, air is replaced by ozone in order to disinfect the water stream. In other embodiments, chlorine is used to disinfect the stream. A wide array of gases may be used based on the desired treatment process selected. In the case of specialty gases, a cylinder has to be connected to the Air and Gas Pumps (22, 23) to be fed into the air dissolution cells.

After air is dissolved into the water stream in the Air Dissolution Chamber (15), the stream enters Flotation Tank (16), where the lighter density particles, typically oil, float to the surface and a moving Scraper (17) sends them to a Collection Tank (18). The Oil Collection Tank (18) has a Discharge Pipe (19) where the oil can be either discharged to a tank, a trailer or pumped to its final destination. The clarified stream enters finally an Effluent Tank (20) which has an Outlet Pipe (21) to allow the clarified water to be either discharged to a tank or pumped to the final destination. The Effluent Tank (20) is located next to the Oil Collection Tank (18) as show in the diagram. Located next to these tanks is the Slag Tank (31) where a waste sludge is collected. A side view of the unit is presented in FIG. 3.

The integrated chemical treatment and sedimentation system of the present invention can be used to treat aqueous waste streams from industrial processes, municipal water, waste water from oil field operations and many more. The versatility of the design allows for using several chemical treatment agents and the recovery of the sludge created, aiding the separation with a sedimentation chamber and an air flotation chamber, which in turn can be used with an alternative gas to provide further disinfection of the clarified water stream. The integrated design allows better efficiency based on the synergy of the different treatments and the flow pattern inside the compact unit.

Economic advantages for using this integrated system include the reduced footprint required by combining several chemical treatments into the flow stream, facilitating the sedimentation of the solids produced and present in the original stream and the flotation of the less dense species, or the disinfection on site of the stream based on the chemical analysis of the original waste stream. The integrated design allows for the possibility of having the complete process in a compact unit which can be mobile to provide service to locations which do not the infrastructure to have a large treatment facility in place, or which require temporary treatment solutions. The design allows also the possibility of creating permanent, large scale treatment facilities for more demanding requirements. The versatility of the processing step options allows for the treatment of a large array of waste streams present in municipal or industrial settings, like oil and gas operations, meat processing plants, dairy plants, tanneries, plating plants, mining acid drainage operation, nuclear waste water, and several others.

### EXAMPLE

An application of this invention is presented using a waste effluent from oil fields located in South Texas. The analysis of the contaminants present in the water stream and the results after treatment are presented in Table 1.

| | Before | Units | After |
|---|---|---|---|
| PROPERTIES | | | |
| pH | 8.1 | s.u. | 6-8 |
| Color | 15 | c.u. | Non-Detectable |
| Conductivity @ 25 C. | 52600 | mmhos/cm | 49800 |
| Solids, Total Dissolved | 43500 | mg/L | 41200 |
| TDS @ 180 C. | | | |
| Solids, Total Suspended | 81 | mg/L | 32 |
| TSS @ 105 C. | | | |
| Turbidity | 103 | NTU | 15 |
| Hardness as CaCO3 | 5080 | mg/L | 760 |
| MAJOR IONS | | | |
| Chloride | 22600 | mg/L | 19200 |
| Sulfate | 132 | mg/L | 112 |
| Calcium | 1720 | mg/L | 258 |
| Magnesium | 189 | mg/L | 28 |
| Potassium | 120 | mg/L | 102 |
| Sodium | 11200 | mg/L | 9520 |
| METALS, TOTAL | | | |
| Barium | 11.0 | mg/L | 1.65 |
| Iron | 3.5 | mg/L | .5 |
| Strontium | 288 | mg/L | 43 |
| TOTAL PETROLEUM | | | |
| HYDROCARBONS | | | |
| nC6 to nC12 | 16 | mg/L | 2.4 |
| >nC12 to nC28 | 44 | mg/L | 6.6 |
| >nC28 to nC35 | 9 | mg/L | 1.35 |
| Total Hydrocarbons | 69 | mg/L | 10.35 |

Based on the chemical analysis of the waste stream in this first example, the treatments were:
a. For reactor number one, NaOH was selected in order to reduce the heavy metal load present.
b. For reactor number two, an anionic polymer was selected to reduce the ionic strength of the stream.
c. For reactor number three, a cationic polymer was selected to reduce the remaining ions in the stream.
d. Air was selected as flotation agent in order to recover the hydrocarbons present in the stream.
e. No disinfection was required.

The results presented are from tests performed at a customer's site with a mobile unit. The flow-rate of waste water in the unit was 50 gpm. The invention was able to reduce the heavy metals content by 85%. A similar value was obtained for hydrocarbon recovery, while suspended solids were reduced by 60%. The water stream was clarified, with no significant coloration at the exit, achieving the main objective of the test requested by the customer.

The following references were found to be instructive in this art by the inventors:
a. Peters, R. W. and L. Shem, “Separation of Heavy Metals: Removal From Industrial Wastewaters and Contaminated Soil,” conf. 9303107-1, Symposium on Emerging Separation Technologies for Metals and Fuels, Palm Coast Fla., 113-18 (March 1993).
b. Peters, R. W., Y. Ku and D. Bhattacharyya, “Evaluation of Recent Treatment Techniques for Removal of Heavy Metals from Industrial Waste Waters”, AIChE Symposium Series, No. 243, Vol. 81, pp 165-203 (1985).
c. J. F. Wentworth and J.R. Hefler, “Process for the Treatment of Water”, U.S. Patent S/N 3082146A (1959).
d. G. Greiner, W. Grunbein, E. Albrecht, “Process for the Treatment of Water”, U.S. Patent S/N 4255257A (1981).
e. R. Wukasch and R. Goodenough, “Chemical Precipitation and Flocculation”, U.S. Patent S/N 3488717A (1967).
f. Y. Fujiwara, “Sedimentation basin”, Japan Patent JPH08238403A (1995).

A legend of the components discussed in the application and shown on the drawings:

| | |
|---|---|
| 1 | Inlet pipe |
| 2 | Influent Tank |
| 3 | First Reactor Tank |
| 4 | First Reactor Tank Agitator |
| 5 | Second Reactor Tank |
| 6 | Second Reactor Tank Agitator |
| 7 | Third Reactor Tank |
| 8 | Third Reactor Tank Agitator |
| 9 | Slanted Plate Precipitation Tank |
| 10 | Slanted Plates |
| 11 | Precipitation Tank Discharge pipe |
| 12 | Air Dissolution Chamber |
| 13 | Air/Gas Inlet |
| 14 | Secondary Air/Gas Inlet |
| 15 | Secondary Air Dissolution Chamber |
| 16 | Flotation Chamber |
| 17 | Moving Scraper |
| 18 | Oil Collection Tank |
| 19 | Oil Discharge Pipe |
| 20 | Clarified water Tank |
| 21 | Clarified Water Discharge Pipe |
| 22 | Primary Air pump |
| 23 | Secondary Air pump |
| 24 | Control Panel |
| 25 | First Chemical Dosing Tank |
| 26 | Second Chemical Dosing Tank |
| 27 | Third Chemical Dosing Tank |
| 28 | First Chemical Dosing pump |
| 29 | Second Chemical Dosing pump |
| 30 | Third Chemical Dosing pump |
| 31 | Sludge Tank |

Terms: ‘Reactor’ refers to a chemical reaction tank.

The inventors claim:

1. An integrated water and waste water treatment system comprising an influent tank, three chemical reactors, each paired with a chemical dosing tank and dosing pump, a mixer and agitator in each chemical tank and dosing tank to aid sedimentation and precipitation in treatment water, a precipitation and sedimentation chamber, an air flotation device, a hydrocarbon recovery component in the air flotation chamber, a disinfection element, an oil separation element, all of which is controlled by a control panel to treat of water and waste water systems.

2. The system set forth in claim 1, in which water containing impurities is pumped to an influent tank until it is full, at which time it begins feeding a first reactor and the first chemical dosing pump starts injecting a first desired chemical species for a first treatment process from a chemical tank at a dosing flow-rate controlled from the control panel by an operator based on the chemical analysis of a subject aqueous stream to be treated, first treating the stream with sodium hydroxide to precipitate heavy metals, the precipitate kept in suspension and the reaction is homogenized by having the tank well mixed by means of an agitator.

3. The system set forth in claim 2, in which the mixture with suspended precipitate enters the second reactor where a second chemical is injected by a chemical dosing pump from a chemical tank at a dosing flow-rate controlled from the control panel by the operator based on the chemical analysis of the problem aqueous mixture and the second chemical is a polymer, coagulant or flocculant that facilitates precipitation or sequestering the precipitates, depending on the type of contaminant to be attacked, and the contents of the second reactor tank are maintained well mixed and the solids suspended by means of an agitator housed on the top of the tank.

4. The system set forth in claim 3 where the second chemical is an anionic or cationic polymer.

5. The system set forth claim 3, in which the treated water exits the second reactor to a third reactor tank, and a desired third chemical is injected by a third dosing pump from a third chemical tank, and the appropriate dosing flow-rate is controlled from the control panel by the operator and based on the chemical analysis of the subject aqueous stream, and the sequestered precipitate compounds generated by the chemical reaction are maintained in suspension by a reactor-mounted agitator ensuring proper contact between the chemicals used and the contaminants, encouraging efficient reactions.

6. The system set as set forth in claim 5, in which the third chemical employed is an anionic polymer, a cationic polymer, or a coagulant.

7. The system set as set forth in claim 5, wherein the treatment stream exits the third reactor tank to enter a slanted plate precipitation tank comprising a series of inclined plates that slow movement of the particles in suspension and precipitate to the bottom of the tank, where they are collected and removed as sludge through a discharge pipe located at the bottom of the tank and the semi-clarified water stream exits the precipitation tank to an air flotation tank where air or a gas is injected.

8. The system set forth in claim 5, wherein the desired chemical species for any reaction tank in the treatment process includes sodium hydroxide, magnesium hydroxide, calcium oxide, aluminum sulfate, ferric sulfate, cation polymers, or anion polymers.

9. The system set forth in claim 7, where air is pumped from a first air pump to the side inlet of a dissolution chamber and a second air pump is connected to via the side inlet of a second dissolution chamber, and the air or gas flow-rate is controlled at the control panel based on the amount of oil or light-density contaminants present in the stream.

10. The system set forth in claim 9, wherein air is replaced by ozone, chlorine, oxygen or carbon dioxide in order to disinfect the water stream.

11. The system set forth in claim 9, in which air or other gases are dissolved into the water stream in the air dissolution chamber, and the waste stream is directed to the flotation tank where less dense particles, such as oil, float to the surface and a moving scraper directs them to a collection tank that releases the collected fluids through a discharge pipe to a tank, trailer or pump.

12. The system set forth in claim 9, in which the clarified treatment water is released from the air flotation tank to an effluent tank which is held until the water is released by the user through an outlet pipe to a tank or pumped to the final destination.
